(19) United States
(12) Patent Application Publication
(10) Pub. No.: US 2023/0256378 A1
(43) Pub. Date: Aug. 17, 2023

(54) AIR CONDITIONING SYSTEM AND METHOD OF CAPTURING CO2 USING THE SAME

(71) Applicant: Qatar Foundation for Education, Science and Community Development, Doha (QA)

(72) Inventors: Abdulkrem AMHAMED, Doha (QA); Ahmed SODIQ, Doha (QA)

(21) Appl. No.: 18/016,180

(22) PCT Filed: Jul. 16, 2021
(86) PCT No.: PCT/QA2021/050018

§ 371 Date: Jan. 13, 2023

Related U.S. Application Data
(60) Provisional application No. 63/052,655, filed on Jul. 16, 2020.

(51) Int. Cl. B01D 53/04; F24F 8/10; B01D 53/047

(52) U.S. Cl. CPC B01D 53/0462; B01D 53/0476; F24F 8/10; B01D 2253/25; B01D 2257/504; B01D 2258/06

(57) ABSTRACT

A system for capturing carbon dioxide from ambient air includes an input port configured to accept ambient air into the system, an air conditioning system configured to draw the ambient air into the input port and reduce a temperature of the ambient air, a filter device configured to capture carbon dioxide from the ambient air after the temperature of the ambient air is reduced by the air conditioning system, and an output port, through which the ambient air is discharged from the system after the ambient air is processed with the filter device.

### PRIORITY CLAIM

This application claims priority to U.S. Provisional Pat. Application No. 63/052,655, filed on Jul. 16, 2020, the entire contents of which are hereby incorporated by reference and relied upon.

### BACKGROUND

The current DAC system employs liquid sorbents for selective removal of CO₂ from ambient air. In the aqueous system, CO₂ in ambient air is absorbed, and the aqueous alkali solution is regenerated at high temperature (>900° C.). However, this regeneration energy is huge and DAC operating cost is high. Therefore, there is a need to develop a new system, for example, with low operating cost and high energy efficiency of regeneration.

### SUMMARY

The present disclosure generally relates to air conditioning systems and methods of capturing CO₂ using the same.

In light of the present disclosure, and without limiting the scope of the disclosure in any way, in an aspect of the present disclosure, which may be combined with any other aspect listed herein unless specified otherwise, a system for capturing carbon dioxide is provided. The system for capturing carbon dioxide from ambient air includes an input port configured to accept ambient air into the system, an air conditioning system configured to draw the ambient air into the input port and reduce a temperature of the ambient air, a filter device configured to capture carbon dioxide from the ambient air after the temperature of the ambient air is reduced by the air conditioning system, and an output port, through which the ambient air is discharged from the system after the ambient air is processed with the filter device.

In some examples, when the filter device is saturated with the captured carbon dioxide, the filter device may be configured to be regenerated to release the captured carbon dioxide.

In some examples, the filter device is regenerated using at least one of a temperature swing adsorption (TSA) method or a pressure swing adsorption (PSA) method.

In some examples, when the filter device is regenerated using the TSA method, the filter device is heated to release the captured carbon dioxide.

In some examples, the system further includes a heater configured to heat the filter device for the regeneration using the TSA method.

In some examples, the heater may include a heating coil attached to the filter device.

In some examples, a waste heat from the air conditioning system may be used to heat the filter device for the regeneration using the TSA method.

In some examples, during the regeneration using the TSA method, the filter device is heated at a temperature in a range of about 70° C. to about 100° C.

In some examples, when the filter device is regenerated using the PSA method, the captured carbon dioxide in the filter device may be released using a vacuum pump.

In some examples, the released carbon dioxide may be stored in a tank configured to store a pure gas.

In some examples, the filter device may include an adsorption filter, and an adsorbent material. The adsorption filter may include a material selected from the group consisting of polymer, carbon, fabric, felt, silicate based material, polypropylene based material, and silicate based material and combinations thereof. The adsorption filter may be modified by the adsorbent material.

In some examples, the adsorbent material may include a nanomaterial selected from the group consisting of carbon nitride, metal-organic framework (MOF), and faujasite (FAU), and combinations thereof.

In some examples, modifying the adsorption filter by the adsorbent material may include grafting the adsorbent material onto the adsorption filter.

In some examples, modifying the adsorption filter by the adsorbent material may include pelletizing the adsorbent material and adding the pelletized adsorbent material to the adsorption filter.

In some examples, modifying the adsorption filter by the adsorbent material may include selectively heating the adsorbent material and thermally fusing the adsorbent material to the adsorption filter.

In another aspect of the present disclosure, which may be combined with any other aspect listed herein unless specified otherwise, a method for capturing carbon dioxide is provided. The method for capturing carbon dioxide from ambient air includes drawing an ambient air into an input port of a system, reducing, by an air conditioning system of the system, a temperature of the ambient air, capturing, by a filter device of the system, carbon dioxide from the ambient air after the temperature of the ambient air is reduced by the air conditioning system, and discharging, through an output port of the system, the ambient air from the system after the ambient air is processed with the filter device.

In some examples, the method may further include regenerating the filter device to release the captured carbon dioxide when the filter device is saturated with the captured carbon dioxide.

In some examples, the filter device may be regenerated using at least one of a temperature swing adsorption (TSA) method or a pressure swing adsorption (PSA) method.

In some examples, the method may further include storing the released carbon dioxide in a tank configured to store a pure gas.

In some examples, the filter device may include an adsorption filter, and an adsorbent material. The adsorption filter may include a material selected from the group consisting of polymer, carbon, fabric, felt, silicate based material, polypropylene based material, and silicate based material and combinations thereof. The adsorption filter may be modified by the adsorbent material.

The reader will appreciate the foregoing details, as well as others, upon considering the following detailed description of certain non-limiting examples including the air conditioning system and method of capturing CO₂ using the same according to the present disclosure.

### BRIEF DESCRIPTION OF THE DRAWINGS

Features and advantages of the technology described herein may be better understood by reference to the accompanying drawings in which:

FIG. 1 shows an example process of removing carbon dioxide based on liquid sorbent.

FIG. 2 shows an example process of removing carbon dioxide based on low temperature solid sorbent.

FIG. 3 shows a schematic diagram of an example system for capturing carbon dioxide according to an example of the present disclosure.

FIG. 4 shows a flowchart illustrating an example method for capturing carbon dioxide according to an example of the present disclosure.

### DETAILED DESCRIPTION

The present disclosure generally relates to air conditioning system and method of capturing CO₂ using the same.

The current state-of-the-art in a DAC system generally employs liquid and/or solid sorbents for selective removal of CO₂ from ambient air. In the aqueous system, CO₂ in ambient air may be absorbed, and the aqueous alkali solution may be regenerated at a very high temperature (e.g., > 900° C.). In an effort to optimize the system, there has been a change of the sorbent from aqueous NaOH to aqueous KOH in order to increase capture efficiency.

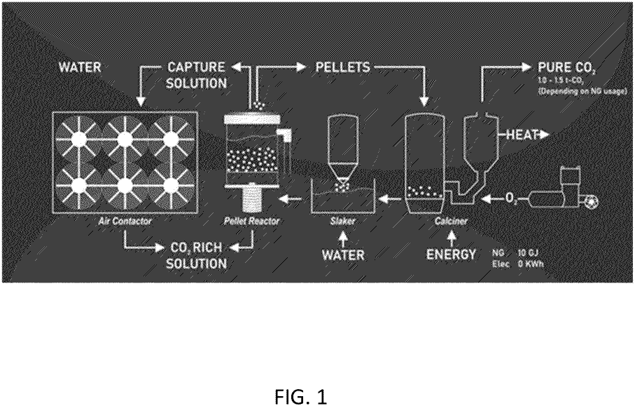

FIG. 1 illustrates an example process of removing carbon dioxide based on liquid sorbent. In this process, CO₂ in ambient air may be selectively absorbed by aqueous solution of KOH to form carbonates and the carbonates may be sent to calciner to energetically release the CO₂. However, this regeneration energy may be huge, which may make solid sorbent application in DAC more attractive than the liquid based sorbents. With solid sorbents, regeneration can be achieved at lower temperature (e.g., < 400° C.). Thus, solid sorbent based DAC may be economically more attractive because its regeneration energy requirement can be supplied from the waste heat from industrial processes, which may eventually lead to lower operating costs.

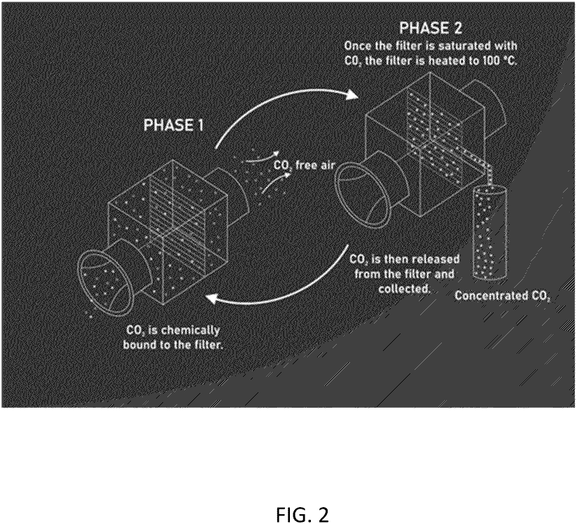

Examples of the solid sorbents may include metal-organic frameworks (MOFs) and amine-based solids. Using the amine-based solids, the solid sorbents may be used to capture CO₂ at ambient conditions and may have a regeneration temperature in the range of 80-100° C. FIG. 2 shows an example process of removing carbon dioxide based on low temperature solid sorbent. In this process, CO₂ in the ambient air may be selectively adsorbed onto a filter by a solid sorbent, and once the filter is saturated with the carbon dioxide, it may be heated to 100° C. temperature for regeneration. The system may be able to capture 80% of CO₂ in ambient air for further conversion of the captured CO₂ to synthetic diesel. The captured CO₂ can be delivered to a nearby greenhouse for agricultural purposes or can be stored to permanently sequestrate CO₂ in geologic formations.

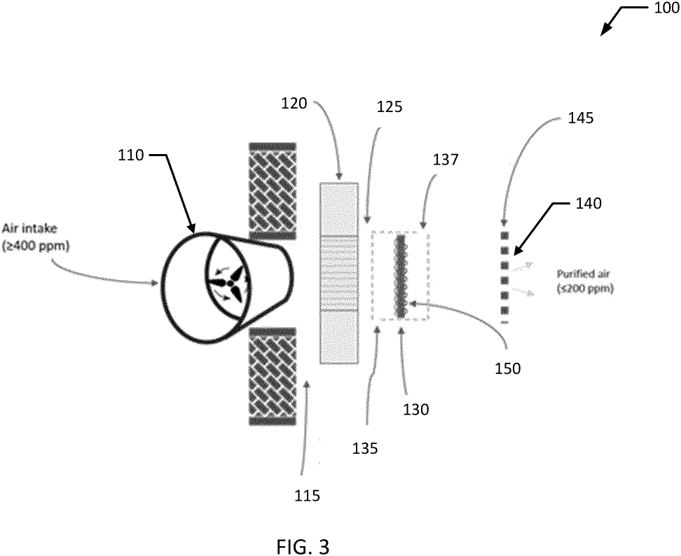

In the present disclosure, a method and a system for capturing carbon dioxide from the ambient air are disclosed. FIG. 3 illustrates a schematic diagram of an example system 100 for capturing carbon dioxide according to an example of the present disclosure. In some examples, the system 100 may include an input port 110, an air conditioning (A/C) system 120, a filter device 130, an indoor A/C frontal panel 145, and an output port 140 in the indoor A/C frontal panel 145.

The input port 110 may be configured to accept ambient air into the system 100. The A/C system 120 may be configured to draw the ambient air into the input port 110 and reduce a temperature of the ambient air. In some examples, the ambient air may be taken into the input port 110 by a suction pressure, which may vary from 5-10 bars depending on the type of the A/C system. The air drawn into the input port 110 and the A/C system 120 may be treated by an embedded A/C filter (e.g., in the A/C system 120) to remove dust particles. Thereafter, the air may go through a refrigeration cycle, in which the temperature may be reduced from a first temperature to a second temperature. The first and second temperatures may change depending on the time of the year, type of the A/C system, and so on. For example, in district cooling applications, the air temperature can be reduced from about 40° C. to about 5° C.

In some examples, the first temperature can be about 55° C. to about 65° C., about 45° C. to about 55° C., about 35° C. to about 45° C., about 25° C. to about 35° C., about 65° C. or less, about 60° C. or less, about 55° C. or less, about 50° C. or less, about 45° C. or less, about 40° C. or less, about 35° C. or less, or about 30° C. or less. In some examples, the second temperature can be about 5° C. to about 15° C., about 15° C. to about 25° C., about 18° C. to about 22° C., about 15° C. or less, about 22° C. or less, or about 25° C. or less.

In some examples, a hot air region 115 may be formed in the front side of the A/C system 120, and a cold air region 125 may be formed in the back side of the A/C system 120. In some examples, the hot air region 115 may have the first temperature, and the cold air region 125 may have the second temperature. In some examples, the hot air region 115 may be formed between the input port 110 and the A/C system 120, and the cold air region 125 may be formed between the A/C system 120 and the filter device 130.

The filter device 130 may be configured to capture carbon dioxide from the ambient air after the temperature of the ambient air is reduced by the A/C system 120. Then, through the output port 140, the ambient air may be discharged from the system 100 after the ambient air is processed with the filter device 130.

In some examples, the filter device 130 may be disposed at a place where the ambient air is discharged from the A/C system 120 right after the refrigeration cycle (e.g., before the cold air is sent to the indoor environment for occupants’ utilization), thereby utilizing the cold air from the A/C system 120 for a low temperature adsorption.

In some examples, the filter device 130 may include an adsorption filter and an adsorbent material. Examples of the adsorption filter may include polymer, carbon, fabric, felt, silicate based material, polypropylene based material, silicate based material, and/or combinations thereof. In some examples, examples of the adsorbent material may include a nanomaterial, such as carbon nitride, metal-organic framework (MOF), nanoscale faujasite (FAU), and/or combinations thereof. The adsorbent material may have a high CO₂ uptake in the ambient air.

In some examples, the adsorption filter may be modified by the adsorbent material. For example, in some examples, the adsorbent material may be grafted onto the adsorption filter. In other examples, the adsorbent material may be pelletized to pellets and added to the adsorption filter (e.g., as a second media layer). The grafting/coating of the adsorbent material on to the adsorption filter may include, for example, a gas-injection approach. For example, the adsorbent material may be selectively heated and thermally fused to the adsorption filter material matrix through spraying. In this way, aspects of the present disclosure may ensure strong adherence between the adsorbent material and the adsorption filter when cooled. The pellets formed from the adsorbent materials may be shaped and conditioned in a way to minimize pressure drop when used with the A/C system.

In some examples, when the filter device 130 is saturated with the captured carbon dioxide, the filter device 130 may be regenerated to release the carbon dioxide captured in the filter device 130. The regeneration can be conducted in a suitable manner, such as by a temperature swing adsorption (TSA) method and/or a pressure swing adsorption (PSA) method. In some examples, for the temperature swing adsorption method, the adsorbent material may releases CO₂ when the filter device 130 is heated to 70° C.-80° C. (in the case of carbon nitride and MOFs) or 80° C.-100° C. (in the case of FAU).

In some examples, a waste heat can be used to heat the filter device 130. For example, a low-grade waste heat 135 from the A/C system 120 (e.g., at about 50° C.) can be used to heat the filter device 130 for regeneration. In some examples, the waste heat from the A/C system 120 may be harvested and combined with electrical heat within the building to achieve the desired regeneration temperature. For the PSA approach, a vacuum pump may be utilized to recover the adsorbed CO₂. In some examples, both of the PSA and TSA methods can be used at the same time.

In some examples, the system 100 may further include a heater configured to heat the filter device 130 for the regeneration using the TSA method. In some examples, the heater may be a heating coil 150 attached to the filter device 130.

According to an example of the present disclosure, direct capture of CO₂ from the atmosphere using air conditioning units is provided. The current A/C system may circulate outdoor air indoors; the system may take in hot air, filter out dust particles, lower the air temperature and then release the air to the building. Apart from dust particles’ separation through the embedded filter, the constituents of the original hot air may remain unaltered. The present technology may provide an approach using swing surface-modified filters to adsorb CO₂ (at about 400 ppm) in the incoming air. When the filter is saturated with CO₂, the filter can be regenerated to release the adsorbed CO₂ using either temperature swing adsorption (TSA) or pressure swing adsorption approaches (PSA) or both.

The recovered CO₂ may be a pure gas and stored in a tank (e.g., an ISO tank). In some examples, the tank may have capability of storing high capacity of gas (e.g., pure gas). In some examples, the filter device 130 may include a CO₂ recover point 137, through which the released CO₂ can be recovered and delivered, for example, to the tank. This pure CO₂ then can be supplied to different end users (e.g. someone that uses the pure CO₂ for greenhouse farming).

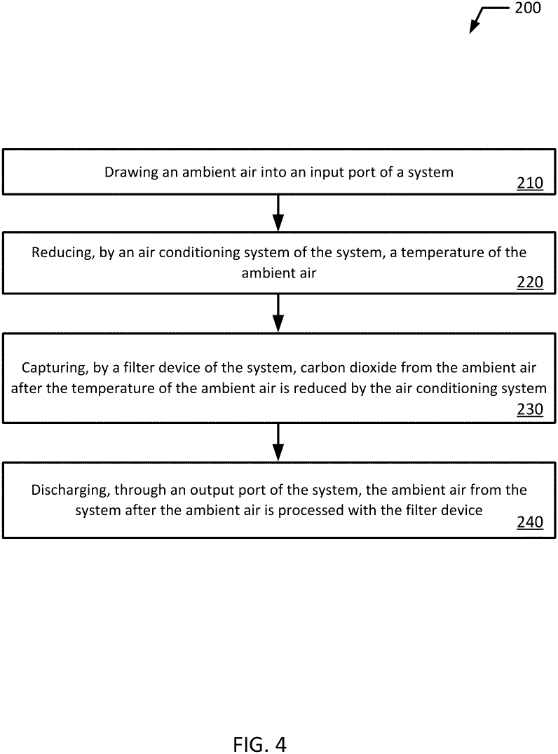

FIG. 4 shows a flowchart illustrating an example method 200 for capturing carbon dioxide according to an example of the present disclosure. Although the example method 200 is described with reference to the flowchart illustrated in FIG. 4, it will be appreciated that many other methods of performing the acts associated with the method may be used. For example, the order of some of the blocks may be changed, certain blocks may be combined with other blocks, and some of the blocks described are optional.

In the illustrated example, an ambient air may be drawn into an input port of a system (block 210). For example, an ambient air may be drawn into the input port 110 of the system 100 due to a suction pressure. Then, a temperature of the ambient air may be reduced, by an air conditioning system of the system (block 220). For example, the temperature of the ambient air drawn into the input port may be reduced from a first temperature to a second temperature, by the air conditioning system 120.

Thereafter, carbon dioxide from the ambient air may be captured, by a filter device of the system, after the temperature of the ambient air is reduced by the air conditioning system (block 230). For example, carbon dioxide from the ambient air may be captured, by the filter device 130, after the temperature of the ambient air is reduced by the air conditioning system 120. Then, the ambient air may be discharged, through an output port of the system, from the system after the ambient air is processed with the filter device (block 240). For example, the ambient air may be discharged, through the output port 140, from the system 100 after the ambient air is processed (e.g., CO₂ removed) with the filter device 130.

In some examples, the method 200 may further include regenerating the filter device to release the captured carbon dioxide when the filter device is saturated with the captured carbon dioxide. The filter device may be regenerated using at least one of a temperature swing adsorption (TSA) method or a pressure swing adsorption (PSA) method. In some examples, the method 200 may also include storing the released carbon dioxide in a tank configured to store a pure gas.

According to an example of the present disclosure, the system may use non-toxic chemicals, such as carbon nitrides as adsorbents, fused onto special filter materials for application in HVAC systems (e.g. air conditioning), especially at low temperature regime after the refrigeration cycle, where adsorption efficiency may be high due to low temperature. The system may also use a waste heat recovered from the A/C system, and this may be combined with other heat source for regeneration.

According to an example of the present disclosure, the system may adsorb CO₂ from the ambient air that has passed through the low temperature regime of the A/C system. It may also use a waste heat recovered from the air conditioning system for regeneration.

According to an example of the present disclosure, the air conditioning system may use non-toxic solid sorbents, which may be quite different in chemistry and application from the liquid sorbents. The captured (pure) CO₂ can then be used for a number of suitable applications, such as agricultural purpose, and also as a starting material for the production of chemicals, such as formic acid.

In some examples, the system 100 may alternatively include a heating system instead of the A/C system 120. In this case, the filter device 130 may be disposed in front of the heating system (e.g., between the input port 110 and the heating system) at region 115 so that the filter device 130 can receive a cold air. In this way, the system 100 may utilize the cold air from the outside (before they go through the heating system) for a low temperature adsorption. The heating system may be configured to draw the ambient air into the input port 110 and increase the temperature of the ambient air. For example, the drawn air may go through a heating cycle, in which the temperature may increase from a first temperature to a second temperature. The first and second temperatures may change depending on the time of the year, type of the A/C system, and so on. In this way, aspects of the present disclosure may not be geographically constrained because it can be applied even in regions where a heating system is usually used instead of an A/C system.

In some examples, the first temperature can be about 5° C. to about 15° C., about 15° C. to about 25° C., about 18° C. to about 22° C., about 15° C. or less, about 22° C. or less or about 25° C. or less. In some examples, the second temperature can be about 55° C. to about 65° C., about 45° C. to about 55° C., about 35° C. to about 45° C., about 25° C. to about 35° C., about 65° C. or less, about 60° C. or less, about 55° C. or less, about 50° C. or less, about 45° C. or less, about 40° C. or less, about 35° C. or less, or about 30° C. or less.

Other configuration/feature/characteristic of the system 100 (e.g., components of filter device 130, regeneration methods, etc.) may be similar to and/or same as the ones described above and, thus, duplicate description may be omitted.

In some examples, the system 100 may be part of a system for air-conditioning an entire building. In other examples, the system 100 may be part of a system for air-conditioning a smaller unit (e.g., a single house, office, etc.). Aspects of the present disclosure may be able to use the existing infrastructure (e.g., air-conditioning unit/heating unit) to produce pure CO₂, thereby not only improving the indoor air quality but also reducing the cost of producing the pure CO₂.

Reference throughout the specification to “various aspects,” “some aspects,” “an example,” “some examples,” “other examples,” or “one aspect” means that a particular feature, structure, or characteristic described in connection with the aspect is included in at least one example. Thus, appearances of the phrases “in various aspects,” “in some aspects,” “certain embodiments,” “an example” “some examples,” “other examples,” “certain other embodiments,” or “in one aspect” in places throughout the specification are not necessarily all referring to the same aspect. Furthermore, the particular features, structures, or characteristics illustrated or described in connection with one example may be combined, in whole or in part, with features, structures, or characteristics of one or more other aspects without limitation.

It is to be understood that at least some of the figures and descriptions herein have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein.

The terminology used herein is intended to describe particular embodiments only and is not intended to be limiting of the present disclosure. As used herein, the singular forms “a”, “an” and “the” are intended to include the plural forms as well, unless otherwise indicated. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term ‘at least one of X or Y’ or ‘at least one of X and Y’ should be interpreted as X, or Y, or X and Y.

It should be understood that various changes and modifications to the examples described herein will be apparent to those skilled in the art. Such changes and modifications can be made without departing from the spirit and scope of the present subject matter and without diminishing its intended advantages. It is therefore intended that such changes and modifications be covered by the appended claims.

1. A system for capturing carbon dioxide from ambient air, the system comprising:
an input port configured to accept ambient air into the system;
an air conditioning system configured to:
draw the ambient air into the input port; and
reduce a temperature of the ambient air;
a filter device configured to capture carbon dioxide from the ambient air after the temperature of the ambient air is reduced by the air conditioning system; and
an output port, through which the ambient air is discharged from the system after the ambient air is processed with the filter device.

2. The system of claim 1, wherein when the filter device is saturated with the captured carbon dioxide, the filter device is configured to be regenerated to release the captured carbon dioxide.

3. The system of claim 2, wherein the filter device is regenerated using at least one of a temperature swing adsorption (TSA) method or a pressure swing adsorption (PSA) method.

4. The system of claim 3, wherein when the filter device is regenerated using the TSA method, the filter device is heated to release the captured carbon dioxide.

5. The system of claim 4, further comprising a heater configured to heat the filter device for the regeneration using the TSA method.

6. The system of claim 5, wherein the heater comprises a heating coil attached to the filter device.

7. The system of claim 4, wherein a waste heat from the air conditioning system is used to heat the filter device for the regeneration using the TSA method.

8. The system of claim 4, wherein during the regeneration using the TSA method, the filter device is heated at a temperature in a range of about 70° C. to about 100° C.

9. The system of claim 3, wherein when the filter device is regenerated using the PSA method, the captured carbon dioxide in the filter device is released using a vacuum pump.

10. The system of claim 2, wherein the released carbon dioxide is stored in a tank configured to store a pure gas.

11. The system of claim 1, wherein the filter device comprises:
an adsorption filter; and
an adsorbent material,
wherein the adsorption filter comprises a material selected from the group consisting of polymer, carbon, fabric, felt, silicate based material, polypropylene based material, and silicate based material and combinations thereof,
wherein the adsorption filter is modified by the adsorbent material.

12. The system of claim 11, wherein the adsorbent material comprises a nanomaterial selected from the group consisting of carbon nitride, metal-organic framework (MOF), and faujasite (FAU), and combinations thereof.

13. The system of claim 11, wherein modifying the adsorption filter by the adsorbent material comprises grafting the adsorbent material onto the adsorption filter.

14. The system of claim 11, wherein modifying the adsorption filter by the adsorbent material comprises pelletizing the adsorbent material and adding the pelletized adsorbent material to the adsorption filter.

15. The system of claim 11, wherein modifying the adsorption filter by the adsorbent material comprises selectively heating the adsorbent material and thermally fusing the adsorbent material to the adsorption filter.

16. A method for capturing carbon dioxide from ambient air, the method comprising:
drawing an ambient air into an input port of a system;
reducing, by an air conditioning system of the system, a temperature of the ambient air;
capturing, by a filter device of the system, carbon dioxide from the ambient air after the temperature of the ambient air is reduced by the air conditioning system; and
discharging, through an output port of the system, the ambient air from the system after the ambient air is processed with the filter device.

17. The method of claim 16, further comprising regenerating the filter device to release the captured carbon dioxide when the filter device is saturated with the captured carbon dioxide.

18. The method of claim 17, wherein the filter device is regenerated using at least one of a temperature swing adsorption (TSA) method or a pressure swing adsorption (PSA) method.

19. The method of claim 17, further comprising storing the released carbon dioxide in a tank configured to store a pure gas.

20. The method of claim 16, wherein the filter device comprises:
an adsorption filter; and
an adsorbent material,
wherein the adsorption filter comprises a material selected from the group consisting of polymer, carbon, fabric, felt, silicate based material, polypropylene based material, and silicate based material and combinations thereof,
wherein the adsorption filter is modified by the adsorbent material.
